(19) United States
(12) Patent Application Publication
(10) Pub. No.: US 2026/0296336 A1
(43) Pub. Date: Oct. 1, 2026

(54) VEHICLE UNDERBODY STRUCTURE

(71) Applicant: TOYOTA JIDOSHA KABUSHIKI KAISHA, Toyota-shi (JP)

(72) Inventor: Nobuyasu NISHIKI, Toyokawa-shi (JP)

(73) Assignee: TOYOTA JIDOSHA KABUSHIKI KAISHA, Toyota-shi (JP)

(21) Appl. No.: 19/629,659

(22) Filed: Mar. 26, 2026

(30) Foreign Application Priority Data
Mar. 28, 2025 (JP) 2025-056992

(51) Int. Cl. B60R 13/08; B60K 13/04

(52) U.S. Cl. CPC B60R 13/0869; B60K 13/04; B60R 13/0876

(57) ABSTRACT

A vehicle underbody structure includes: an exhaust pipe; a unit component; an insulator; a protective plate; an undercover; and an insulator cover member. The undercover includes a first opening exposing a portion of the insulator cover member, and an outer peripheral surface of the exhaust pipe is covered by the insulator cover member and the insulator at the front of the unit component. The insulator cover member includes a shielding wall portion configured to shield a space between the exhaust pipe and the protective plate, the shielding wall portion extending downward along the exhaust pipe from the engine compartment toward the undercover, and a second opening that opens toward the underside of the vehicle, the second opening communicating with an underside space of the vehicle via the first opening.

### RELATED APPLCATION

The present application claims priority to and incorporates by reference the entire contents of Japanese Patent Application No. 2025-056992 filed in Japan on Mar. 28, 2025.

### BACKGROUND

The present disclosure relates to a vehicle underbody structure.

JP2018140678A discloses a vehicle underbody structure including a battery pack positioned below a floor panel, a bracket protecting the battery pack from road surface interference, an exhaust pipe extending along the side of the battery pack, and a heat shielding member positioned between the battery pack and the exhaust pipe.

### SUMMARY

In the configuration described in JP2018140678A, when hot air flows from the engine compartment toward the battery pack, the hot air enters above the bracket. This causes the hot air to stagnate within the space covered by the bracket in front of the battery pack, potentially causing thermal damage to the battery pack.

There is a need for a vehicle underbody structure that is able to suppress thermal damage caused by the exhaust pipe to unit components positioned below the floor panel.

According to one aspect of the present disclosure, there is provided a vehicle underbody structure including: an exhaust pipe connected to an engine housed within an engine compartment in a front of a vehicle, the exhaust pipe extending toward a rear of the vehicle; a unit component positioned adjacent to the exhaust pipe below a floor panel of the vehicle and rearward of the engine compartment; an insulator configured to protect the unit component from heat of the exhaust pipe; a protective plate mounted to a front of the unit component and configured to protect the unit component from road surface interference; an undercover configured to cover an underside of the vehicle; and an insulator cover member positioned forward of the unit component and configured to cover the insulator by covering a lower portion of the exhaust pipe, wherein the undercover includes a first opening exposing a portion of the insulator cover member, an outer peripheral surface of the exhaust pipe is covered by the insulator cover member and the insulator at the front of the unit component, the insulator cover member includes a shielding wall portion configured to shield a space between the exhaust pipe and the protective plate, the shielding wall portion extending downward along the exhaust pipe from the engine compartment toward the undercover, and a second opening that opens toward the underside of the vehicle, the second opening communicating with a underside space of the vehicle via the first opening.

### BRIEF DESCRIPTION OF THE DRAWINGS

FIG. 1 is a schematic diagram showing the vehicle in an embodiment;

FIG. 2 is a skeleton diagram for explaining the vehicle structure;

FIG. 3 is a schematic diagram showing the vehicle underbody structure;

FIG. 4 is a diagram illustrating the vehicle underbody structure;

FIG. 5 is a diagram illustrating the arrangement relationship between the insulator cover member, the exhaust pipe, the insulator, and the undercover;

FIG. 6 is a diagram illustrating the shielded space covered by the insulator cover member and the insulator;

FIG. 7 is a diagram illustrating the air flow when high-temperature air within the shielded space is discharged into the lower space;

FIG. 8 is a diagram illustrating how high-temperature air flowing through the shielded space exits through the opening in the insulator cover member and the opening in the undercover into the lower space; and

FIG. 9 is a diagram illustrating the vehicle underbody structure in an alternative embodiment.

### DETAILED DESCRIPTION

The vehicle underbody structure according to an embodiment of the present disclosure will now be described in detail. Note that the present disclosure is not limited to the embodiment described below.

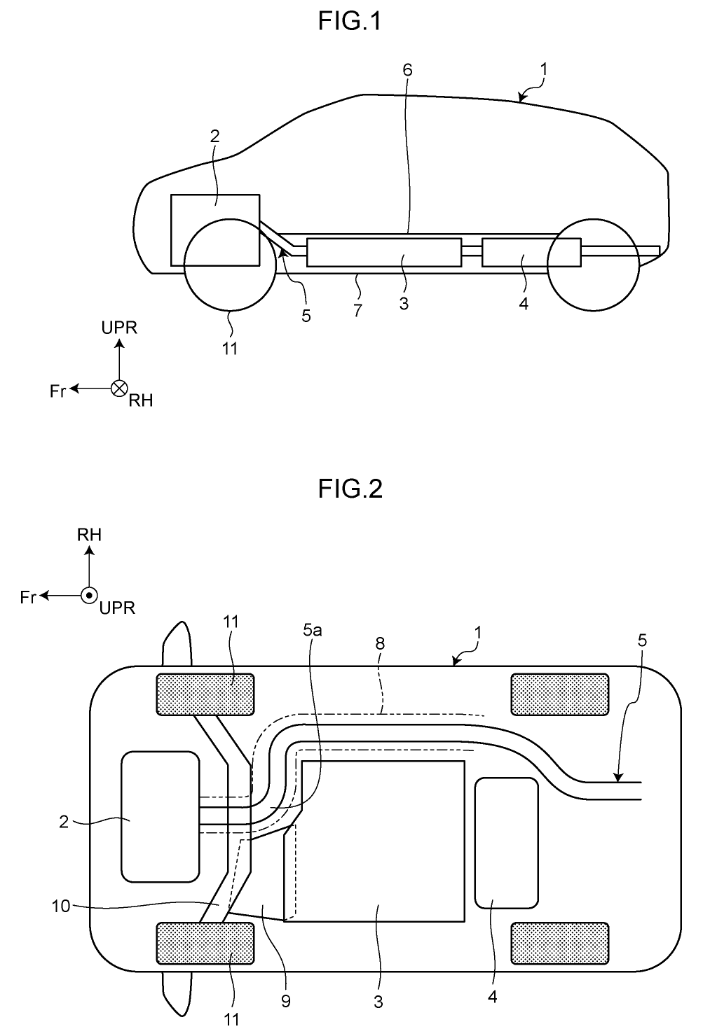

FIG. 1 is a schematic diagram showing a vehicle in an embodiment. A vehicle 1 is a hybrid electric vehicle.

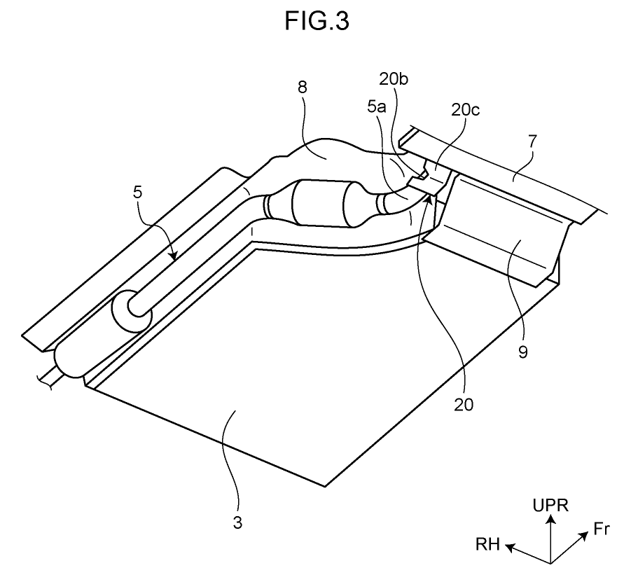

As illustrated in FIGS. 1 and 2, the vehicle 1 includes an engine 2, a battery pack 3, a fuel tank 4, an exhaust pipe 5, a floor panel 6, an undercover 7, an insulator 8, a protective plate 9, a front suspension member 10, a front wheel 11, and rear wheels. Vehicle 1 includes an insulator cover member 20 as its underbody structure, as illustrated in FIG. 3.

The engine 2 is positioned in the front section of vehicle 1. An engine compartment is provided in the front section of vehicle 1, and engine 2 is housed within the engine compartment.

The battery pack 3 is positioned below the floor panel 6. The battery pack 3 is a unit component mounted rearward of the engine compartment and beneath the floor of vehicle 1. The battery pack 3 includes multiple battery modules and a case for housing the battery modules.

The case consists of a lower case and an upper cover. Inside the case, the battery modules and a junction box are housed. The junction box is positioned at the front of the lower case. As illustrated in FIG. 2, an exhaust pipe 5 is adjacent to the battery pack 3.

The fuel tank 4 is positioned behind the battery pack 3.

The exhaust pipe 5 is connected to the engine 2 and directs the engine's exhaust out of the vehicle 1. A catalytic converter and a muffler are connected to the exhaust pipe 5. The exhaust pipe 5 extends downward and rearward from the engine compartment, running beneath the floor panel 6 towards the rear of the vehicle 1. The exhaust outlet of the exhaust pipe 5 is positioned at the rear of the vehicle 1 and opens rearward. As illustrated in FIG. 1, in front of the battery pack 3, the exhaust pipe 5 extends downward from the engine compartment toward the undercover 7. As illustrated in FIG. 2, the exhaust pipe 5 extends rearward from the engine compartment, passing above the front suspension member 10.

As illustrated in FIGS. 2 and 3, the exhaust pipe 5 has a bend portion 5a that bends in the vehicle width direction in front of the battery pack 3. The exhaust pipe 5 is positioned near the battery pack 3 and extends along the side of the battery pack 3. The exhaust pipe 5 extends toward the rear of the vehicle 1 on the outer side of the battery pack 3 in the vehicle width direction.

The undercover 7 is a protective member covering the underside of the vehicle 1. The undercover 7 is a member for protecting the vehicle 1 from road surface interference. The undercover 7 includes multiple members. For example, it includes a share panel disposed below the battery pack 3. The insulator 8 is a heat shielding member that protects unit components from the heat of the exhaust pipe 5.

These unit components are mounted under the floor of vehicle 1. Insulator 8 is a component designed to suppress thermal damage to the unit components caused by exhaust pipe 5. As illustrated in FIGS. 2 and 3, insulator 8 is provided along the direction of extension of exhaust pipe 5, covering the outer surface of exhaust pipe 5. Insulator 8 is positioned above and to the side of exhaust pipe 5. The wall surface of the insulator 8 faces the outer peripheral surface of the exhaust pipe 5.

The protective plate 9 is a rigid member attached to the front of the battery pack 3 to protect it from road surface interference. The protective plate 9 functions as a falling object guard to protect the battery pack 3 from falling objects.

As illustrated in FIG. 3, the protective plate 9 is fixed to the bottom wall portion of the battery pack 3's lower case. The protective plate 9 is fastened to the lower case using fastening members. The protective plate 9 is a member connecting the front suspension member 10 and the battery pack 3. The front portion of the protective plate 9 is attached to the front suspension member 10, and the rear portion of the protective plate 9 is attached to the battery pack 3. The front suspension member 10 supports the left and right front wheels 11. As illustrated in FIGS. 2 and 3, the protective plate 9 is positioned on the left side of the exhaust pipe 5's bend portion 5a in the vehicle width direction.

In the vehicle 1 configured in this manner, an insulator 8 is provided for the exhaust pipe 5 extending rearward and downward from the engine compartment. If the wall of the insulator 8 were extended to the vicinity of the undercover 7, it would occupy space intended for the wheel housings and piping. Therefore, the wall of the insulator 8 is formed low. Consequently, hot air escapes from the wall of the insulator 8 to the outside in front of the battery pack 3. As a result, hot air flows into the area above the protective plate 9, and the heat from the hot air reaches the battery pack 3. Therefore, in the vehicle's underbody structure, an insulator cover member 20 is provided as the bottom surface of insulator 8.

The insulator cover member 20 is positioned in front of battery pack 3 and covers insulator 8 and exhaust pipe 5, facing the bottom surface of exhaust pipe 5. The insulator cover member 20 is a component designed to suppress thermal damage to the battery pack 3 caused by high-temperature air from the engine compartment and to suppress thermal damage to the battery pack 3 caused by high-temperature air further heated by the exhaust pipe 5. If unit components are exposed to high-temperature air, sealants and electrical components may degrade, affecting durability. In this case, high-temperature air within the engine compartment flows into the unit section after being heated by the exhaust pipe 5. Furthermore, since the insulator 8 has an open lower section, high-temperature air leaking downward may reach the unit components. Therefore, to prevent the unit components from being exposed to high-temperature air, the insulator cover member 20 shields the flow of high-temperature air from the engine compartment side to the battery pack 3 side. Specifically, the insulator cover member 20 shields the flow of air from the engine compartment side into the space above the protective plate 9.

As illustrated in FIG. 3, the insulator cover member 20 is positioned near the bend portion 5a of the exhaust pipe 5. For example, the insulator cover member 20 is set on the exhaust pipe 5 upstream of the bend portion 5a. Since the insulator 8 forms a wall downstream of the bend portion 5a, high-temperature air does not flow toward the battery pack 3.

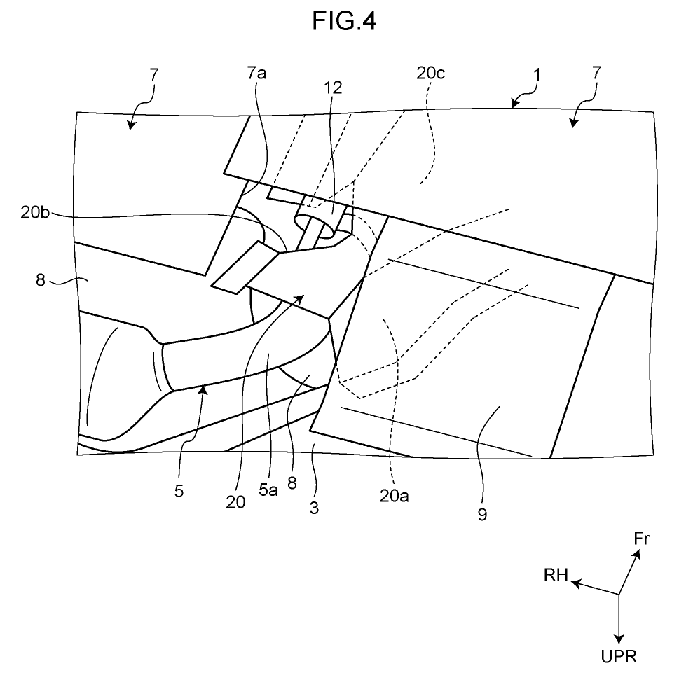

As illustrated in FIG. 4, the undercover 7 has a first opening 7a through which a portion of the insulator cover member 20 is exposed. Since the exhaust pipe 5 is arranged to avoid the front suspension member 10, it is desirable to provide the first opening 7a in a portion near the bend portion 5a.

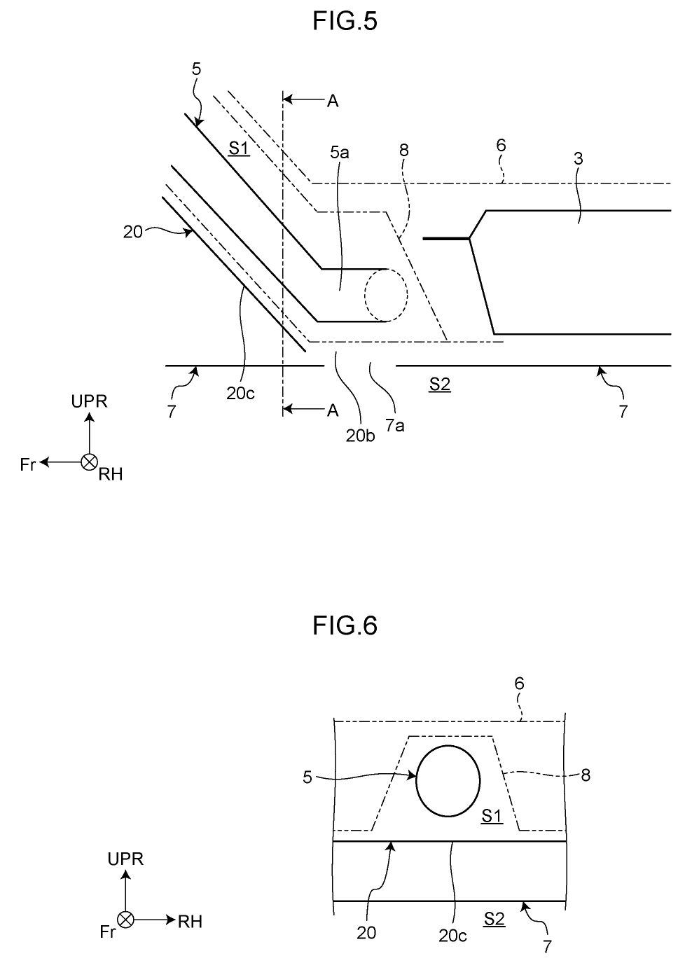

As illustrated in FIGS. 5 and 6, the outer peripheral surface of the exhaust pipe 5 is covered by the insulator cover member 20 and the insulator 8 in the front area of the battery pack 3. The insulator cover member 20, together with the insulator 8, surrounds the exhaust pipe 5 to partition a shielding space S1. The shielding space S1 is the space where the wall surface of the insulator cover member 20 and the wall surface of the insulator 8 cover the outer peripheral surface of the exhaust pipe 5. The insulator cover member 20 has a shielding wall portion 20a, a second opening 20b, and a lower wall portion 20c.

The shielding wall portion 20a is a wall portion that shields the space between the exhaust pipe 5 and the protective plate 9. The shielding wall portion 20a extends rearward and downward along the exhaust pipe 5 from the engine room side toward the undercover 7 side.

The second opening 20b is an opening directed downward and serves as an outlet for high-temperature air within the shielding space S1 to flow out beneath the vehicle 1.

The second opening 20b communicates with the space S2 below the vehicle 1 via the first opening 7a. As illustrated in FIG. 5, the first opening 7a is positioned in the height direction near the lower end of the insulator cover member 20. At least a portion of the second opening 20b is positioned forward of the first opening 7a.

As illustrated in FIG. 5, the first opening 7a and the second opening 20b are provided at a position just before the high-temperature air rushes downward and rearward from the engine compartment to suppress thermal damage to the protective plate 9 from the exhaust pipe 5. Specifically, the rear end of the insulator cover member 20 is positioned to coincide with the location where the first opening 7a must be provided on the undercover 7.

As illustrated in FIG. 4, a leg portion 12 is attached to the exhaust pipe 5. The leg portion 12 is a member for attaching the exhaust pipe 5 to the vehicle body. The exhaust pipe 5 is supported by the leg portion 12. The leg portion 12 is positioned near the bend portion 5a of the exhaust pipe 5. The insulator cover member 20 has a cutout portion near the leg portion 12, creating a space for venting high-temperature air to the outside. This cutout portion becomes the second opening 20b for discharging high-temperature air downward.

The lower wall portion 20c is positioned below the exhaust pipe 5 and faces the outer peripheral surface of the exhaust pipe 5 from below. As illustrated in FIG. 4, the shielding wall portion 20a and the lower wall portion 20c are provided up to the vicinity of the bend portion 5a of the exhaust pipe 5 to shield the high-temperature air flowing toward the battery pack 3 side.

As illustrated in FIG. 5, the lower wall portion 20c is an inclined wall portion extending rearward and downward along the exhaust pipe 5. As illustrated in FIGS. 4, 5, and 6, a portion of the lower wall portion 20c is positioned above the undercover 7. The second opening 20b is provided near the lower end of the lower wall portion 20c.

As illustrated in FIG. 5, within the range where the lower wall portion 20c is set, the cross-sectional area of the shielding space S1 is formed to be small, resulting in a state of high pressure loss. In other words, the cross-sectional area of the shielding space S1 is made small, increasing the pressure loss of the high-temperature air flowing through the shielding space S1.

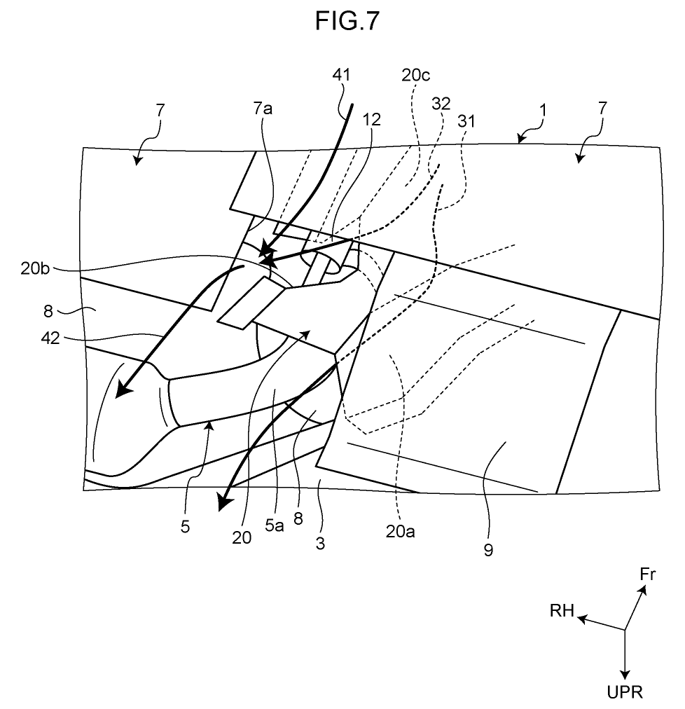

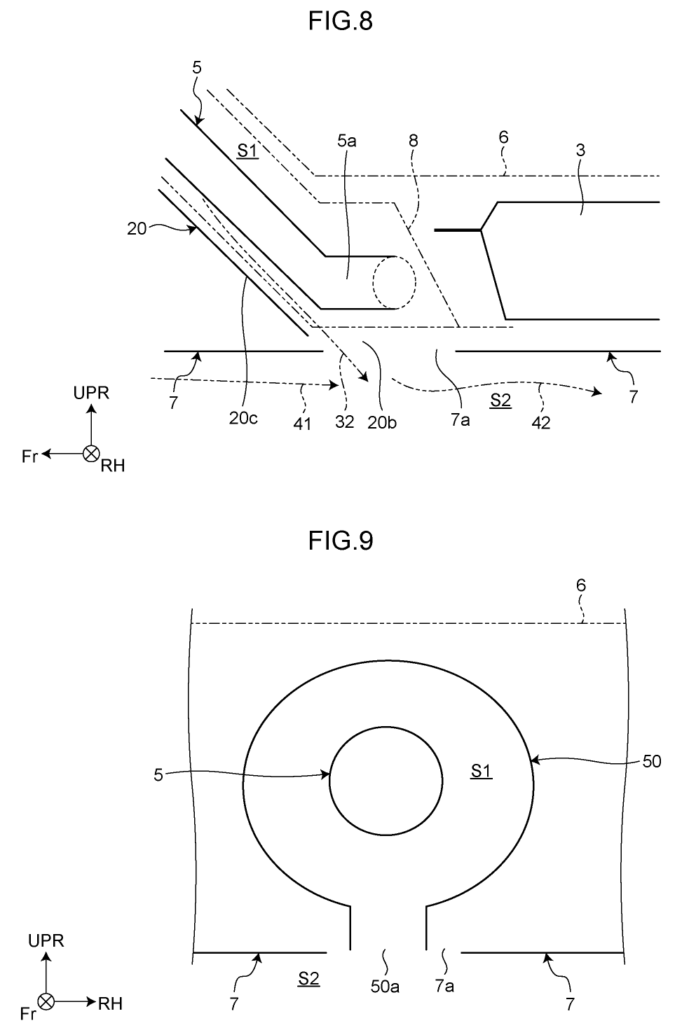

As illustrated in FIGS. 7 and 8, the insulator cover member 20 regulates the flow of high-temperature air in front of the battery pack 3. It utilizes the negative pressure in the external air passage beneath the undercover 7 relative to the intermediate gap holes provided in the insulator cover member 20. At the second opening 20b near the leg portion 12, the flow of air 41 below the undercover 7 pulls the high-temperature air 32 within the shielding space S1 toward the lower space S2. This air merges below the undercover 7, creating a downward flow of high-temperature air 42. At this time, the air 41 flowing below the first opening 7a of the undercover 7 creates a negative pressure state in the lower space S2. Consequently, during vehicle 1 operation, the high-temperature air 32 near the exhaust pipe 5 is sucked downward through the first opening 7a of the undercover 7. Furthermore, reducing the cross-sectional area of the shielding space S1 and increasing the pressure loss allows the flow velocity of the high-temperature air 32 to be slowed. This relatively increases the flow velocity of the air 41, enhancing the effect of the negative pressure. In this way, the high-temperature air 42 may be vented below the undercover 7, suppressing thermal damage to the battery pack 3. This avoids exposing the battery pack 3 to the high-temperature air.

Furthermore, since the insulator 8 forms the front wall of the battery pack 3, the high-temperature air colliding with this front wall insulator 8 flows downward toward the floor. These features prevent the flow of high-temperature air toward the battery pack 3 side.

Furthermore, since high-temperature air within the shielding space S1 flows out toward the underside of the undercover 7, the temperature of the undercover 7 may rise due to this high-temperature air. However, the battery pack 3 is separated from the undercover 7. Therefore, thermal damage to the battery pack 3 via a heat path through the undercover 7 may be suppressed.

As described above, according to the embodiment, the flow of hot air in front of the battery pack 3 may be adjusted by the insulator cover member 20, suppressing thermal damage to the battery pack 3 caused by the exhaust pipe 5.

Furthermore, in an alternative configuration of the vehicle 1's underbody structure, as illustrated in FIG. 9, it includes a double pipe 50 with an insulator function. The double pipe 50 is provided around the exhaust pipe 5. The double pipe 50 has an outlet portion 50a opening downward. The undercover 7 has a first opening 7a provided near the outlet portion 50a of the double pipe 50. During vehicle 1 operation, the structure utilizes the airflow beneath the undercover 7 to draw the high-temperature air inside the double pipe 50 outward via negative pressure.

According to this modified example, since the temperature outside the double pipe 50 is low, the distance between the double pipe 50 and the undercover 7 may be reduced. This increases the freedom in setting the first opening 7a.

This disclosure enables suppression of heat damage caused by the exhaust pipe to unit components located below the floor panel.

Although the disclosure has been described with respect to the specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A vehicle underbody structure comprising:
an exhaust pipe connected to an engine housed within an engine compartment in a front of a vehicle, the exhaust pipe extending toward a rear of the vehicle;
a unit component positioned adjacent to the exhaust pipe below a floor panel of the vehicle and rearward of the engine compartment;
an insulator configured to protect the unit component from heat of the exhaust pipe;
a protective plate mounted to a front of the unit component and configured to protect the unit component from road surface interference;
an undercover configured to cover an underside of the vehicle; and
an insulator cover member positioned forward of the unit component and configured to cover the insulator by covering a lower portion of the exhaust pipe, wherein
the undercover includes a first opening exposing a portion of the insulator cover member,
an outer peripheral surface of the exhaust pipe is covered by the insulator cover member and the insulator at the front of the unit component,
the insulator cover member includes
a shielding wall portion configured to shield a space between the exhaust pipe and the protective plate, the shielding wall portion extending downward along the exhaust pipe from the engine compartment toward the undercover, and
a second opening that opens toward the underside of the vehicle, the second opening communicating with an underside space of the vehicle via the first opening.

2. The vehicle underbody structure according to claim 1, wherein
the insulator cover member is positioned below the exhaust pipe and includes a lower wall section facing a lower portion of the outer peripheral surface of the exhaust pipe, and
the second opening is provided in a vicinity of a lower end of the lower wall section.

3. The vehicle underbody structure according to claim 2, wherein at least a portion of the second opening is provided closer to the front of the vehicle than the first opening.

4. The vehicle underbody structure according to claim 3, wherein the first opening is provided in a vicinity of the insulator cover member in a height direction.

5. The vehicle underbody structure according to claim 1, wherein the unit component includes a battery pack.
